(19) United States
(12) Patent Application Publication
(10) Pub. No.: US 2026/0050333 A1
(43) Pub. Date: Feb. 19, 2026

(54) MAGNETIC AND PRESSURE SENSING JOYSTICK/THUMB STICK

(71) Applicant: AZOTEQ HOLDINGS LIMITED, Nicosia (CY)

(72) Inventors: Frederick Johannes BRUWER, Paarl (ZA); Frederick Johannes BRUWER, Jr., Paarl (ZA); Daniel Barend RADEMEYER, Paarl (ZA); Wikus WOLMARANS, Paarl (ZA)

(21) Appl. No.: 19/301,059

(22) Filed: Aug. 15, 2025

(30) Foreign Application Priority Data
Aug. 16, 2024 (ZA) 2024/06293
Oct. 24, 2024 (ZA) 2024/08031
Nov. 4, 2024 (ZA) 2024/08302
Dec. 19, 2024 (ZA) 2024/09821
Mar. 13, 2025 (ZA) 2025/02235

(51) Int. Cl. G06F 3/0338; G01D 5/14; G01L 1/14; G01L 5/22; G06F 3/01

(52) U.S. Cl. CPC G06F 3/0338; G01D 5/142; G01L 1/14; G01L 5/223; G06F 3/016

(57) ABSTRACT

A joystick/thumb stick that uses a single central magnet to determine the position of a user activated lever, and which includes force sensing circuitry to provide additional information for calibration and switch selection purposes.

### CROSS-REFERENCE TO RELATED APPLICATION

The present application claims priority from South Africa applications ZA 2024/06293, filed Aug. 16, 2024, ZA 2024/08031, filed Oct. 24, 2024, ZA 2024/08302, filed Nov. 4, 2024, ZA 2024/09821, filed Dec. 19, 2024, and ZA 2025/02235, filed Mar. 13, 2025, contents of which are hereby incorporated by reference into this application.

### BACKGROUND

Joysticks or thumb sticks are very popular in gaming applications but are also frequently used in the control of industrial machinery. A typical joystick is designed around a system using two orthogonal axes, where a rotation about each axis is measured separately to determine a position of a force lever when said force lever is activated by a user. The terms ‘joystick’ and ‘thumb stick’ in the context of this invention refer to the same device and will henceforth be used interchangeably.

Popular measurement techniques in this regard include, for example, a resistive rheostat mechanism, which operates with a slider contact but is susceptible to wear and tear due to friction. More recently, magnetic/Hall effect units for each axis started to become a popular alternative. However, both systems have several moving parts which leads to additional cost and complexity of the system. The resistive solutions in particular often do not perfectly return to zero points, leading to the well-known ‘stick drift’ problem typically encountered in gaming controllers.

Prior art in this field can be found in Wehlman et al. (U.S. Pat. No. 12,038,776 B2), Olsson et al. (US 2010/0265176 A1) and Sirohiwala et al. (U.S. Pat. No. 11,353,912 B2).

It is an objective of this invention to provide a joystick that addresses the aforementioned challenges, and that provides extra functionality which leads to beneficial results in its use. It is a further objective of this invention to minimize moving parts and the number of components required to implement standard joystick functions.

### SUMMARY OF THE INVENTION

A joystick in accordance with this invention includes a single magnet, that is attached in a known orientation to a lever that a user actuates, and magnetic field sensors which are used to determine the orientation of the magnet and replicate the output as per a two-axis joystick solution. This approach effectively produces a point on a Cartesian plane that relates to the position of the force lever under user actuation.

In a specific embodiment of the invention, the magnetic field sensors are four Hall effect sensors laid out in a horizontal plane in an integrated circuit (IC) and are used to measure the magnetic field of the magnet. This means that the vertical (Z-axis) component of the magnet's magnetic field is used to then determine the position, orientation or movement of the force lever, i.e. the lever that is used by the user to operate the thumb stick. In an alternative embodiment, tunnel magneto resistor (TMR) sensors that are integrated into an IC are used to measure the position, orientation or movement of the force lever.

A spring mechanism is used to return the force lever to its zero or near zero (or null/neutral) position i.e. when the user is not pushing or tilting the lever in a direction. A force sensing mechanism may be used to determine if the user is in contact with the force lever and if not, the system may continuously or periodically recalibrate the zero position and as such greatly enhance the ability to avoid stick drift. A touch and vertical press event may be derived from the force sensing information.

The force sensing mechanism is preferably integrated or combined with a switch structure, such as a tactile switch, that is activated in accordance with the action of state-of-the-art joysticks when the user presses downwards on the joystick beyond a predetermined force level. The terms ‘pressure’ and ‘force’ are used interchangeably in this context.

A benefit of using a force sensing mechanism as an alternative to a switch structure is that the joystick is able to detect how much pressure is applied to the joystick in the downwards direction. A further benefit is that this pressure information allows for an adjustable activation or ‘click’ point to be set, i.e. a predetermined pressure or force threshold may be applied. This means that the force sensing mechanism may be configured to register a user switch or click at a force level that is lower or higher than that of the typical state-of-the-art tactile button.

In a specific embodiment, the force sensing mechanism uses a flexible metallic piece that is positioned close to an inductive coil and when a user touches the force lever, the pressure placed on the force lever pushes the flexible metallic piece away from the inductor. This has the distinct benefit of being highly sensitive, since the metallic piece is operational within an exponentially changing magnetic field region of the inductor.

Alternatively, the force sensing mechanism is combined with an electromechanical switch which typically provides tactile feedback, which is a beneficial property to have in terms of user experience. However, if the force sensing mechanism is implemented without an electromechanical switch, it is possible to provide a similar user experience for tactile feedback using a haptic actuator mechanism.

If haptics are used, further functions may be announced to the user. For example, when pressing the joystick in a forward direction, every increase or step in that direction may be announced and when relaxing, a different (or similar) haptic actuation may be activated. Also, when reaching a maximum, a specific haptic feedback sequence may be provided to inform the user.

The design of the force sensor may be such that a very small amount of movement is required (for example in the range of a few microns or tens of microns) and a very small amount of pressure (for a tenth or a hundredth of a Newton) can be measured. If the force sensor is designed in this manner, the force sensor may act as a user touch detector, since the force resulting from a user's thumb merely resting on the joystick will be sufficient for the force sensor to detect a user touch on the joystick.

In accordance with this invention, a touch or no-touch condition can be detected with several types of force sensors, for example strain gauges, capacitive sensors, piezo technology, etc. In a specific embodiment, inductive force sensing is used for its benefits over other technologies. Said benefits include, for example, the fact that inductive sensing is less susceptible to wet conditions. Furthermore, it does not suffer from the signal degradation of capacitive sensing when the joystick has a poor electrical earth reference.

In another specific embodiment, differential capacitive sensing is used as the force sensing mechanism; this has the unique benefit of remaining stable in varying environmental conditions.

An effective way to integrate the inductive touch sensing function with the user downward pressure switching function is also proposed in the detail section below using an inductor that is formed on a layer or multiple layers of a PCB (printed circuit board). As is known in the art, the inductor's or inductors' sensing performance may be improved by adding magnetic materials, for example ferrite layers, or sections of ferrite and the inductor can also be constructed using discrete components.

The shape of the magnet used may take the form of a sphere or a cylindrical shaft (rod) as their magnetic field distributions are similar and thus both shapes can be measured by the same horizontal sensor IC with multiple magnetic field sensors (for example Hall-effect plates or TMR elements).

The joystick output may be in the form of a serial data communication protocol, such as I2C or SPI. Alternatively, it may be in the form of a digital output or outputs. Other suitable output methods include but are not limited to pulse width modulation (PWM) methods or analogue voltage signals.

In a further embodiment, multiple magnetic Hall-effect sensors are used to also determine Z-axis (or vertical) movement of the magnet.

With a mechanical construction that allows for small vertical movement when the user touches the joystick lever, the magnetic sensors can determine such user contact. Furthermore, using the vertical movement information, the magnet's rotational or tilt information can be corrected or improved in terms of linearity and accuracy.

This is very useful for the situation where the user performs downward pressure on the lever to affect a “click” function since, as previously noted, the state-of-the-art switch is a standard electromechanical switch with a tactile feel, which requires significant Z-axis movement to achieve switch actuation. The vertical movement results in a change in distance between the magnet and the magnetic sensors which affects the readings. But if a force sensing mechanism that is combined with an electromechanical switch is used with the magnetic sensors, it is possible to separate the vertical and rotational information to maintain better accuracy and stability of the lever position determination even with the magnet movement in the Z-axis.

In another embodiment the spring that is providing the return to center (or restoring) force is also used as a conductor for capacitive sensing, i.e. to create a conductor between the user and the circuitry on the PCB. At the user contact area, electrical connection is not required as the capacitance to earth created by, for example, a user finger proximity or touching a plastic (or other non-conducting material) surface creates enough of a change in capacitance that can be measured. The bottom of the spring may make contact with conducting tracks on the PCB and these tracks are linked to capacitive measuring circuitry. The objective is to sense when a user touches the user interface lever, using capacitive sensing without requiring additional electrical wires or connections.

In yet another embodiment, the use of a switch on the bottom pcb can be avoided by providing a switch on the top of the force lever that will influence the capacitance measurement. For example, the system can still detect a user coming into close proximity or touching the user interface part of the force lever by, for example, capacitive sensing, but an electromechanical switch (dome or push button) can be designed into the top part to make or break a connection of an area to the touch measurement IC. In this way, both touching (for wake up, stick drift avoidance and auto-calibration) and a click function can be recognized using the single connection that connects the top part of the user interface surface with the capacitive measurement IC. This can be achieved with a separate wire connection dedicated for touch sensing purposes, or the spring may act as the conductive medium to convey the touch and click function information to the measurement IC.

### BRIEF DESCRIPTION OF THE DRAWINGS

FIG. 1—A typical thumb stick implementation based on measurement of rotation around two axes (Prior Art).

FIG. 2A—A side view of a thumb stick implemented in accordance with this invention showing a single magnet and magnetic sensor and an inductive force sensor.

FIG. 2B—A side view of an alternative configuration of the inductive sensor mechanism.

FIG. 3—A side view with additional members to cover a top opening of a housing.

FIG. 4A—Shows a metal bracket used for detecting downward pressure on a force lever that is combined with a push button switch.

FIG. 4B—A detailed illustration of the metal bracket with a push button switch and an inductor for inductive sensing.

FIG. 4C—Pin-type metal bracket for inductive sensing.

FIG. 4D—A differential capacitance sensor for force sensing.

FIG. 5—Side view of an alternative embodiment with protection mechanisms.

FIG. 6—Implementation using magnetic sensors to detect Z-axis movement of a magnet.

FIG. 7—Shows a technique which is similar to that in FIG. 6, but with capacitive sensing.

FIG. 8—Top view of a pcb under a touch area on top of a force lever.

FIG. 9—Side view of the force lever showing an electrical connection and a switch for altering capacitance.

### DETAILED DESCRIPTION

The description below is exemplary and is not intended to be seen as the only way to implement the invention described. The examples are to make the concepts clear to a person skilled in the art.

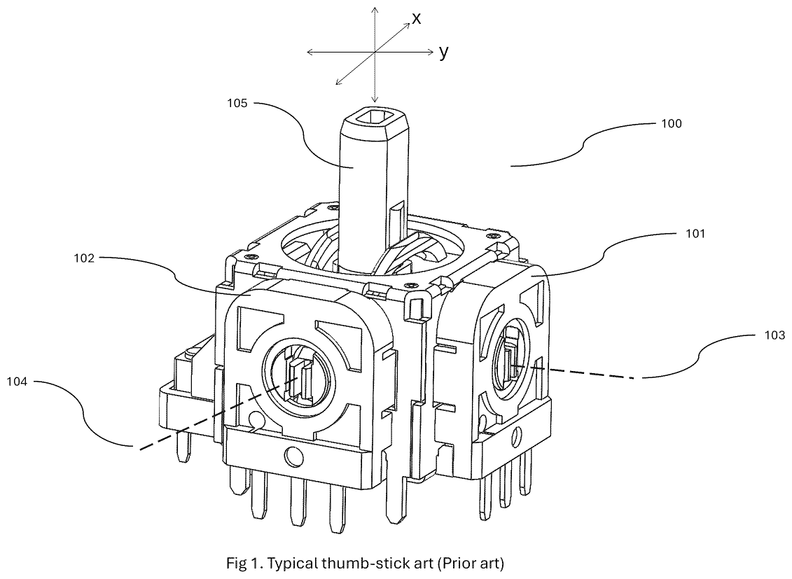

In FIG. 1 a typical implementation of a joystick 100 is shown. Measurement pods 101 and 102 can be based on various types of technology e.g. rheostat, Hall effect or inductive. However, this prior art solution is fundamentally based on the concept of using two orthogonal axes 103 and 104 and measuring rotation about each axis. This information is then combined to determine the position or orientation of a force lever 105. Rotation about the axis 103 is caused by movement in the shown X-direction, and about the axis 104 by movement in the Y-direction. If the lever 105 is pushed in an X-direction, the rotation of lever 105 about the axis 103 is measurable by the measurement pod 101. If the lever 105 is pushed in a Y-direction, then the rotation of lever 105 about the axis 104 is measurable by the measurement pod 102.

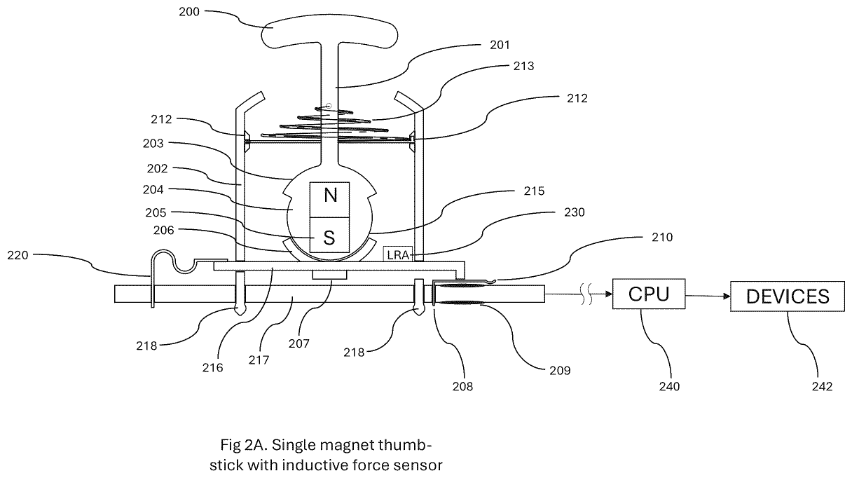

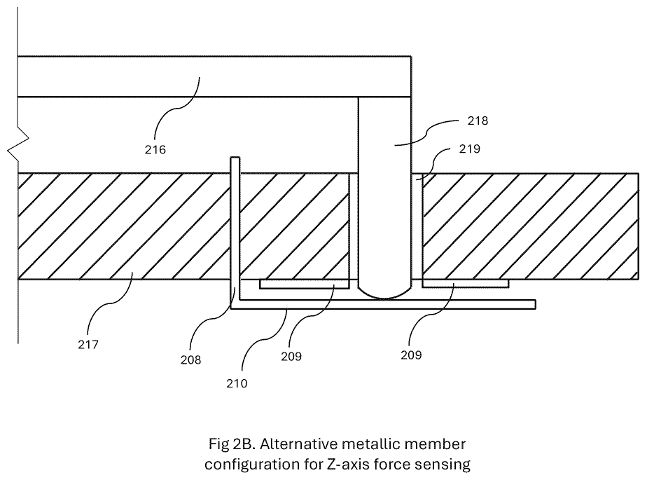

In FIG. 2A a side view of a joystick implementation in accordance with the invention is shown. The joystick 198 has a top cover 200 that comes into contact with a user (not shown). The top cover 200 is attached with a shaft or force lever 201 to an upper part 203 of a housing structure 204 which may be ball shaped. A cylindrical magnet 205 is glued to or otherwise positioned inside the housing structure 204. In another embodiment the housing structure 204 can completely surround the magnet 205, and the magnet 205 can also be a ball-shaped magnet.

A lower part 215 of the housing structure 204 is seated in a floor (claw) structure 206 in which it can freely (with lowest friction feasible) rotate and move. The floor structure is supported on one side by a printed circuit board (pcb) 216 inside a joystick housing 202. In the embodiment as shown in FIG. 2 the pcb 216 is positioned to rest on one side on an inductive measurement structure 210 that comprises a metal bracket 208 that enables inductive sensing of vertical movement when the top cover 200, lever 201, magnet 205, pcb 216 and floor structure 206 are moved together under pressure from a user touch (not shown). A flexible portion 210 of the metal bracket 208 is moved closer to inductor 209 formed on a printed circuit board 217. The inductors 209 may be in the form of a conductive coil, which may be formed by pcb traces or conductive wires suitably attached to the pcb 217.

The magnetic measurement circuit 207 moves in synchronism with the shaft 201 when the user exerts downwards pressure onto the top cover 200. This ensures that the magnetic measurements to determine the force lever angle remain unchanged by any vertical force applied to the force lever 201.

The inductor(s) 209 positioned on the pcb 217 can for example be used to detect movement of the flexible portion 210 of the metal bracket 208 that is soldered into or otherwise attached to the pcb 217. While FIG. 2A indicates that the metal bracket 208 is soldered onto the pcb 217 in a through-hole configuration, it shall be appreciated that a surface mount method is also suitable. The inductor(s) 209 may also be formed using other forms such as, for example, discrete components.

The pcb 216 circuitry is connected to the main pcb 217 circuitry with terminals 220 that are designed to allow for a certain movement of the pcb 216 under user downwards pressure without degrading.

The equivalent of a state-of-the-art joystick switch closure can be detected as a downward pressure affects the measured inductance of the inductor(s) 209 when the user presses the top cover 200 downwards with a force exceeding a predefined minimum level.

An LRA (linear resonant actuator) 230 may provide haptic feedback with regards to the “switch closure” decision. The haptic actuator 230 may also be used to provide user feedback as a user (not shown) pushes the top cover 200 in a lateral direction to accomplish an X- or Y-direction command. Furthermore, the haptic actuator 230 may be used to provide specific feedback when the joystick is moved to any of its limits. A buzzer (not shown) may be used as an alternative to the LRA 230, or in addition to the LRA 230, for user feedback.

In a further embodiment the inductor(s) 209 that is used to detect the downwards user force can also be used to affect a haptic feedback signal by acting as a solenoid when current flows through the inductor(s) 209 from a power source (not shown) associated with a product with which the joystick is used.

The measurement circuit 207 comprises magnetic field sensors, such as Hall-effect plates or TMR elements (not shown) which may be positioned below the magnet 205 either on the inside the of housing 202 or on the pcb 217. The sensor IC 207 may comprise several magnetic field sensors (for example 4 Hall-effect plates in a horizontal plane) or magnetic sensing structures on one or more integrated circuit(s) to accurately determine the magnet 205's orientation which in turn can be used to determine the position or orientation of the joystick shaft or lever 201 under actuation of a user (not shown). In other words, the position or orientation of the force lever 201 can be determined to provide a similar metric as is accomplished by a traditional dual axis type joystick as shown in FIG. 1.

The sensor IC 207 may be used to monitor the position or orientation of the lever 201 and also to monitor a vertical force impressed by a user (not shown). In this case, the inductor(s) 209 is electrically connected to the sensor IC 207 via the pcb 217, through terminals 220 and via the pcb 216. In an embodiment where the sensor IC 207 is placed on the pcb 217, the electrical connection to the inductor(s) 209 may be simplified. Alternatively, the vertical force measurements are made by another controller (not shown).

The force lever 201 is connected to a spring 213 that always applies a restoring force to move the lever 201 back to a center or zero position in the XY (horizontal) plane. The terminology XY-plane refers only to the user operating the lever 201 to tilt in any sideways direction, but not in a vertical (or Z-axis) direction. The spring 213 is held in place by a holding mechanism 212 that is part of the housing 202. The spring 213 may be attached to the force lever 201 and housing 202 in a way to prevent permanent horizontal rotation of the top cover 200 (and also the lever 201 and the magnet 205). The spring 213 may be spiraling upwards or downwards or may be flat. It is preferred that the spring 213, when in position, applies a slight downwards pressure on the lever 201 and all components attached to the lever 201.

The joystick housing 202 can be attached in various ways to the pcb 217 in order to have a stable positioning relationship between the magnet 205 and the sensor IC 207, in an embodiment where the sensor IC 207 is placed onto the pcb 217. The embodiment in FIG. 2A shows an exemplary attachment that is simple and cost-effective, where the joystick housing 202 is furnished with a plurality of mounting pins 218 that click into the pcb 217.

Vertical force sensing accomplished by the metal bracket 208 together with inductor(s) 209, is important for augmenting the “return to zero” performance. This is a critical function and a significant problem in many state-of-the-art products. If for any reason the force lever 201 does not return to the true zero position when the user (not shown) loses contact with the joystick top cover 200 then the vertical force sensing information can be used for recalibration purposes. For example, when a drone is operated using the joystick the drone is guaranteed to hover in one place when the lever 201 and top cover 200 are released. There can be no stick drift when the vertical force sensing system detects no touch. The recalibration procedure may be executed immediately when a user loses touch with the joystick, such that when the user touches the top cover again, a perfect or near-perfect zero point or position is already established. The terms ‘near perfect’ and ‘near zero’ may be understood to mean a point or position that is within a predetermined error margin from the true zero point or position.

Information from the IC 207 is processed by a CPU (control processing unit) 240 to implement actuation or movement of a device 242 e.g. a gaming display, a drone, or any other joystick responsive mechanism, in a manner which corresponds to the sensed orientation and position of the force lever.

The recalibration required, as aforesaid, is preferably accomplished by the CPU 240 executing a calibration algorithm to establish an updated zero position e.g. upon detecting that a user is not in contact with the thumb stick nor with the lever 201.

A significant benefit of the inductive force sensing approach is that it works irrespective of user gloves or presences of liquids. These scenarios cannot be reliably handled by a capacitive sensing method.

FIG. 2B shows an alternative configuration of the inductive force sensing system shown in FIG. 2A. In this exemplary embodiment, the metal bracket 208 is positioned such that the flexible portion 210 of the metal bracket 208 is positioned on the bottom side of PCB 217 instead of on the top side as illustrated in FIG. 2A. Additionally, an inductor 209 is placed on the bottom layer of the PCB 217. The PCB 217 has a hole 219 from its top layer to its bottom layer and through a core of the coil inductor 209. A pin member 218 that is connected to or integral with PCB 216 is inserted through the hole 209 and makes contact with the flexible portion 210 of the metallic bracket 208. The key difference between this embodiment and the one in FIG. 2A is that in this embodiment, when a vertical force is applied to the top cover 200, said force will result in the flexible portion 210 moving away from the inductor 209, instead of moving the flexible portion 210 closer to the inductor 209 as in FIG. 2A. This is a significant improvement over the embodiment in FIG. 2A, because the flexible portion 210 starts near the inductor 209 and any slight change in position of the flexible portion 210 near the inductor will lead to a larger change in inductance relative to the embodiment of FIG. 2A. This is because the magnetic field near the inductor's coils is stronger than when it is further away, and so an interfering member such as the flexible portion 210 can induce a greater initial change in inductance. This is then ideal to promote the detection of slight touches.

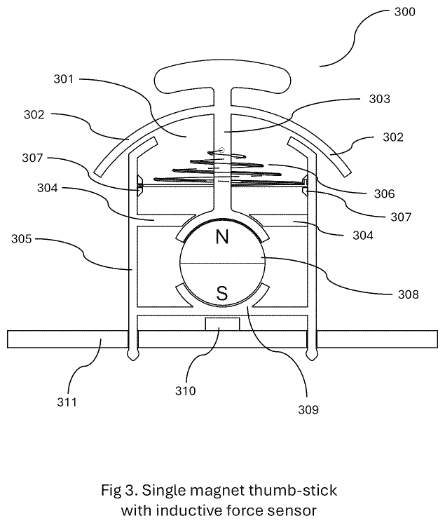

FIG. 3 shows an opening 301 of a joystick 300 can be protected using curved plates 302 that are attached to a lever 303. The plate 304 attached to the housing 305 can also be used to prevent the lever 303 (and all components attached to it) from being pulled too far upwards. The magnet 308 is fixed to the lever 303. The orientation of the magnet may be determined according the requirements of the magnetic field sensors (not shown) on the sensor IC 310 on the pcb 311.

The spring 306 can also be flat in this embodiment and may be held in place by a holding mechanism 307 attached to the housing 305.

The material used to form the curved floor structure 309 wherein the magnet 308 rests is preferably of a smooth material that will not be abrasive towards the magnet over time and result in reliability or accuracy problems. In other words, the magnet 308 and the floor structure 309 must form a low-friction system. Alternatively, the magnet 308 may be encapsuled in the material of the lever 303.

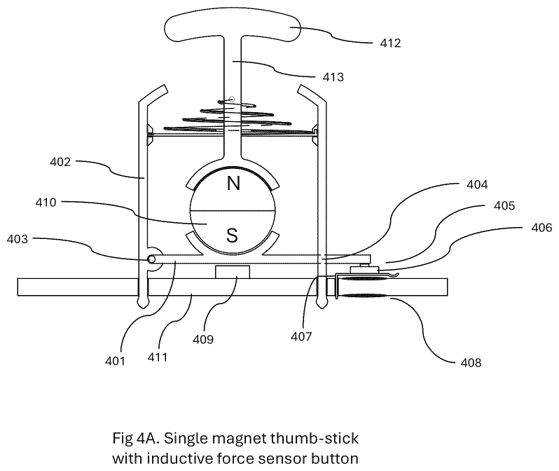

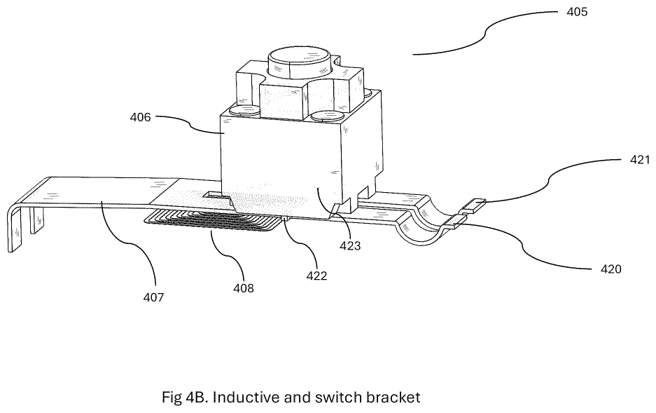

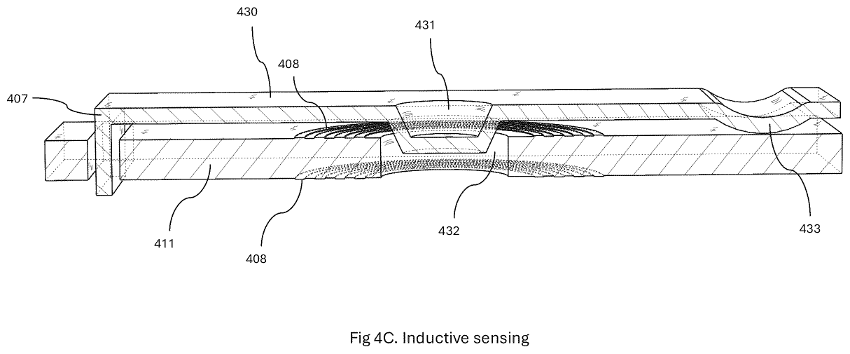

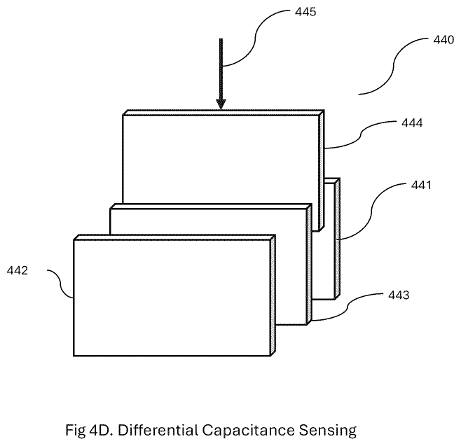

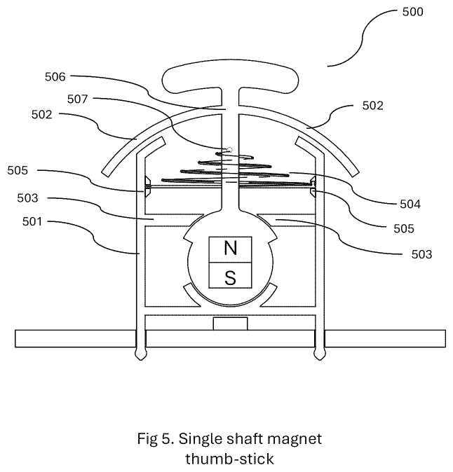

FIG. 4A shows that a floor structure (or pcb) 401 is supported by the housing 402 on one side by means of a hinge mechanism 403, but on another side the floor structure 401 protrudes through a joystick housing 402 at a point 404 and rests on a sensor structure 405 (see FIG. 5) which comprises a push button 406 or another suitable tactile switch that is mounted upon a metal bracket 407 above an inductor(s) 408. When pressure exceeding the specified limit of the switch 406 is applied, the switch 406 will click closed. Then, the ohmic closure of switch 406 can be measured, or the abrupt change in inductance of inductor(s) 408 can be used to recognize closure of the switch 406, as will be explained hereinafter.

A sensor IC 409 is used to measure the magnetic field emanating from a magnet 410 and may be positioned on the pcb 411 or on the bottom side of the floor structure 401. In the latter case, the IC 409 will move up and down in close relation to the up and down movement of the magnet.

FIG. 4B shows the configuration of the sensor structure 405 in greater detail. A metal bracket 407 is soldered or otherwise attached to the pcb 411 shown in FIG. 4A. Downwards pressure, for example when the user touches the top cover 412 in FIG. 4A, causes downwards pressure on a middle part of the switch 406, moving it closer to the inductor(s) 408 causing a change in the measured inductance. When more pressure is applied, at some point the switch 400 closes and electrically connects a first part 420 to a second part 421 of the metal bracket 407, thus causing a bigger eddy current loop to occur, which significantly affects the measured inductance, i.e. a step change is observed in the measured inductance due to the sudden formation of a bigger eddy current effect. This requires that a first terminal 422 of the switch 406 is electrically connected, via soldering or other means, to the first part 420 of the metal bracket 407, and a second terminal 423 of the switch (shown as a hidden view) is electrically connected to the second part 421 via soldering or other means.

In this way, a joystick contact (or no contact) event of the user can be determined from the inductive measurements from the inductor(s) 408 as the metallic bracket 407 slightly bends toward the inductor(s) 408 due to a user finger's weight; additionally a closure event of the switch 406 is determined, with the switch 406 also beneficially providing a tactile click when closed. The switch 406 may have a much flatter form factor.

FIG. 4C shows more details of the metallic bracket 407. As downward pressure is applied to a surface 430, the metallic bracket 407 moves closer to the coil(s) 408 and influences the measured inductance of the coil(s) 408 through eddy currents flowing in the material of metallic bracket 407. The sensing resolution, especially at the start of the downward pressure being applied (i.e. when the initial contact is made by the user), can be improved by modifying the bracket to have a pointed form 431 that penetrates a hole 432 in the pcb 411 within the core of the inductor coil 408. A bend 433 is added to the metallic bracket 407 to help maintain a desired off-set, typically in the range of a few millimeters, above the coil(s) 408, and also to help the metallic bracket 407 to return to its resting position when the user (not shown) releases the downward pressure that is applied to the joystick.

In another embodiment, the downward click switch selection function is performed by measuring the downward pressure with the inductive sensing means, and not by using a electromechanical switch 406. In this embodiment, the angle of the force lever 413 (FIG. 4A) can be considered to calculate a force level to be exceeded for the click to be performed. This overcomes the problem arising from a mechanical construction wherein significantly different force levels are required to activate the electromechanical switch based on the angle of the force lever 413. User feedback can be provided by a haptic actuator (see FIG. 2).

FIG. 4D shows an exemplary sensor structure 440 that uses capacitance instead of inductance to measure the Z-axis movement of the joystick. The sensor structure 440 comprises a first transmitting electrode plate 441, a second transmitting electrode plate 442 and a receiving electrode plate 443. The electrodes 441, 442 and 443 may be integrated as copper pours into the pcb 411 and thus replace the inductor 408. A dielectric interfering member 444 (such as FR-4 or plastic) may be attached to the floor structure 401, so that when pressure is applied to the top cover 412, the force is translated to the floor structure 401 and also to the interfering member 444, causing the interfering member 444 to move downwards in direction 445. As the interfering member 444 moves downwards, its overlap with electrodes 441 and 443 increases, which then also increases the mutual capacitive coupling between the first transmitting electrode 441 and the receiving electrode 403. Said mutual capacitive coupling is measurable by a suitable capacitance measurement IC (not shown) and may be used to deduce how much pressure is applied to the joystick top cover 412. However, as is the case with the inductive sensor system in FIG. 4A, the sensor IC 409 may be used to perform not only magnetic measurements, but also the capacitance measurements.

Furthermore, the sensor structure 440 may be used as a differential capacitance sensor, which is a specialized mutual capacitance sensor wherein the mutual capacitance coupling between electrodes 441 and 443 are subtracted from the mutual capacitance coupling between the electrodes 442 and 443, and vice versa. The sensing information resulting from such subtractions, as described in prior art, is highly immune to temperature contamination and provides high sensing resolution.

FIG. 5 shows an exemplary mechanical structure 500 that helps to prevent dirt or other unwanted materials entering the joystick housing 501 by covering the top side with a layer 502. The elements 503 inside the housing 501 can also help to prevent the joystick from being pulled apart by any upward forces exerted on the force lever 506. Similar to other embodiments, a spring member 504 is positioned inside the joystick housing 501, and may be attached to said housing 501 by means of position elements 505. The other end of the spring may be suitably attached to the lever 506 at a mounting point 507, herein indicated as a mounting hole into which a tip of the spring 504 can be fixed.

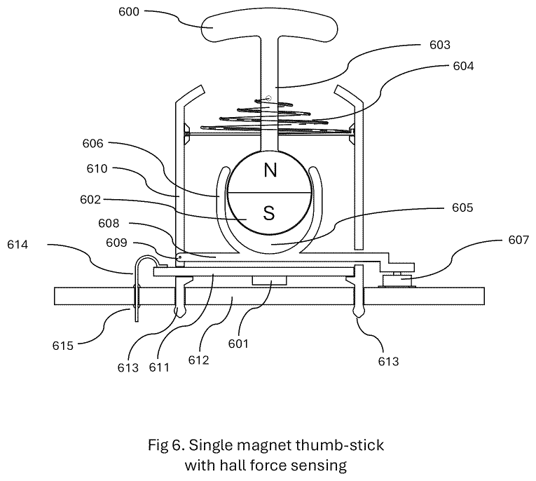

FIG. 6 illustrates an embodiment of the joystick of the invention wherein multiple magnetic sensors, for example, but not limited to 4 Hall effect sensors are designed as part of a sensing integrated circuit (IC) 601 and wherein the magnetic sensors (not shown) are used to sense magnetic fields of a magnet 602 in order to determine the vertical movement and/or the XY-position of a force lever 603 with a top cover 600 acting as the user interface surface.

The force lever 603 is returned to a zero or neutral position through a spring 604 (or another mechanism). In this embodiment the spring 604 also applies a slight upwards force on the lever 603 that is attached to a spherical magnet 602 (that may alternatively be a cylindrical rod type magnet). When the user (not shown) touches the top cover 600, a slight downwards force is exerted and this pushes the magnet 602 downwards (z-axis movement) into a space 605. This downward movement can be detected through the magnetic sensors (not shown) in the sensor IC 601. The shape of the claw structure 606, wherein the magnet 602 moves, is important. In this exemplary implementation it has a curved top side matching the circumference of the magnet 602 (or magnet holder 203 as in FIG. 2A) that allows the degrees of movement required by the force lever 603, but it is also such that the magnet 602 cannot easily move out to the top. The sides of the claw structure 606 are straight to allow slight Z-axis movement of the magnet 602 to allow downwards pressure to move the magnet 602 into the space 605. A bottom section of the space 605 matches the curve of the magnet 602 to enable accurate rotation measurements when the user (not shown) moves the top cover 600 in typical joystick operations while there is also a downwards pressure on the top cover 600 such that the magnet 602 makes contact with the lower curve of the space 605. When there is no user touch, the spring 604 moves the magnet 602 upwards within the claw structure 606.

A separate function is that the force lever 603 movements in the XY plane are translated into rotational movement of the magnet 602 irrespective of the downward (Z-axis) force sensing detection mentioned above, and this XY-plane movement is also determined from the magnetic sensor measurements of the sensor IC 601.

A desirable function for a joystick is that the user (not shown) can exert downwards pressure in excess of a predetermined minimum force level to actuate a typical electromechanical push button type switch 607, irrespective of the orientation of the force lever 603 (i.e. the force lever 603 is upright or at an angle). In FIG. 6, the mounting structure (claw) 606 that keeps the magnet 602 in position is part of a layer structure 608 that may on one side be fixed at a point 609 to the housing 610 and on another side is supported by the switch 607. When the user exerts pressure above a predetermined level, the switch 607 will “click” downwards and this will typically cause a change in the orientational measurement/determination of the force lever 603. However, by using the redundancy of information available in respect of the multiple magnetic sensors (not shown), the Z-axis movement can be determined, and this can be used to improve the position and orientation determination of the force lever 603.

The switch 607 output can be directly provided to the rest of the application circuitry (not shown). The tactile feeling of the switch 607 click can be felt by the user through a contact surface 600. When the user releases the pressure, the internal spring mechanism of the switch 607 will push the layer structure 608 back to its normal position.

The pcb 611 in this case remains stationary and the magnetic sensor IC 601 can be mounted above or below the pcb 611, or can in fact form part of the main pcb 612 of a product (not shown) with which the joystick is associated. However, making the IC 601 part of the joystick can assist in calibration during manufacturing of the joystick.

The switch 607 may be positioned inside or outside (as shown) the joystick housing 610.

The joystick may comprise a mounting structures 613 that can assist with positioning the joystick into a product. The terminals 614 can be soldered to the main pcb 612 at points 615.

An important aspect of the invention is that the multiple magnetic sensors provide enough information to determine Z-axis information as well as rotational information of the magnet 602 and the combination of this information can be used to more accurately determine the position of the force lever 603 even with Z-axis movement happening.

In a specific embodiment, an Azoteq integrated circuit (acting as the sensor IC 601) with four Hall plates (forming the magnetic sensors), all in the same plane, is used to provide information to a microprocessor (not shown) to perform the calculations to determine the user interactions with the joystick.

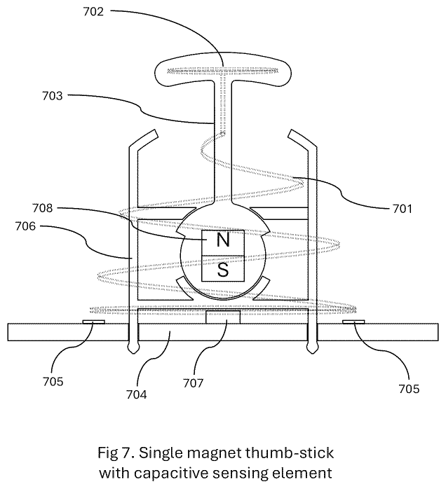

FIG. 7 depicts a capacitive sensing approach to detecting a user touch and proximity. The spring member 701 is used to enable capacitive proximity measurement/detection of, for example, a user finger (not shown) approaching the top part of a user interface lever 702, which is formed as an integral part of the spring 701 that returns the lever to the resting or center position when no force is exerted on the force lever 703 by the user.

On the pcb 704 there are open tracks 705 that have a capacitive coupling to the spring 701. The spring 701 may also make physical contact with the open tracks 705 to form an electrical connection instead of a capacitive coupling. The tracks 705 are then electrically connected to the capacitance measurement circuit (not shown). The tracks 705 are also positioned such that the spring 701 can make a connection at several positions on the pcb 704 irrespective of the direction the user pushes the force lever 703. In this embodiment, the spring 701 is wrapped around an exterior of the housing 706. The sensor IC 707 includes a plurality of magnetic field sensors (not shown) to measure the rotation of the magnet 708 due to a user tilting the lever 703. The sensor IC 707 may additionally act as the capacitance measurement circuit and the tracks 705 may be connected to the sensor IC 707 via the pcb 704.

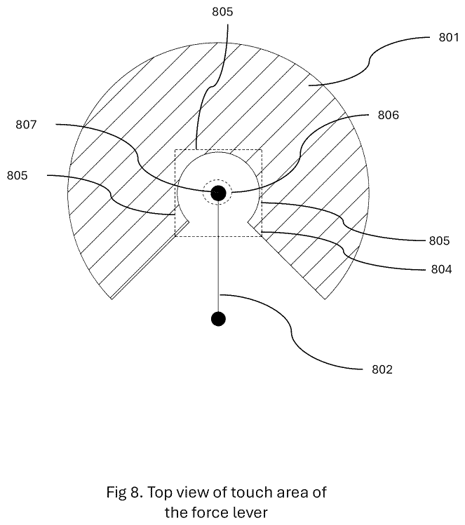

In FIG. 8 an example of a metal structure 801 is shown with a dome switch 804 that can form a connection between the structure 801 and a connection 802 to a capacitance measurement circuit (not shown). The surface area of the dome switch 804 may vary according to the application. The switch can also be normally open or normally closed.

The metal structure 801 forms a capacitance to earth that is influenced by the user. This is the basis of all state-of-the-art self-capacitive type detection and will not be elaborated on here. Importantly, it is now disclosed that the presence of a dome switch 804 may beneficially contribute to the capacitive sensing approach. In the case where the dome switch 804 is normally open, its edges 805 are in electrical contact with the metal structure 801. Thus, the dome switch 804 and the metal structure 801 together form a metal electrode. A stud 806 of the dome switch 804, when the dome switch 804 is not pressed, is positioned a small vertical distance above an electrical end point 807. A weak capacitive coupling will thus exist between the electrode structure (formed by the metal structure 801 and the dome switch 804), and the electrical end point 807. When a user (not shown) applies slight pressure onto the switch 805 (which may occur simply from the weight of a finger), the stud 806 moves closer to the electrical end point 807, thereby increasing the capacitive coupling. Therefore, the mere touch of a user's finger creates a slight but measurable first change in capacitance that may be detected by an appropriate capacitance measurement circuit (not shown).

If the user (not shown) further applies sufficient pressure to the dome switch 804, the dome switch may collapse such that the stud 806 makes electrical contact with the end point 807. In this case, a sudden second change in the capacitance measured may occur (comparable to a step change), since the weak capacitive coupling between the connection 802 and the electrode system (made up of the metal structure 801 and the dome switch 804) is now replaced with an electrical connection. This second change may be associated with a switch click or press event. This switch function can be used to replace the switch function that is normally present at a bottom and on the side of a state-of-the-art thumb stick.

The first change in capacitance may be compared to a first threshold and the second change in capacitance to a second threshold by the capacitance measurement circuitry to discern a touch from a switch event.

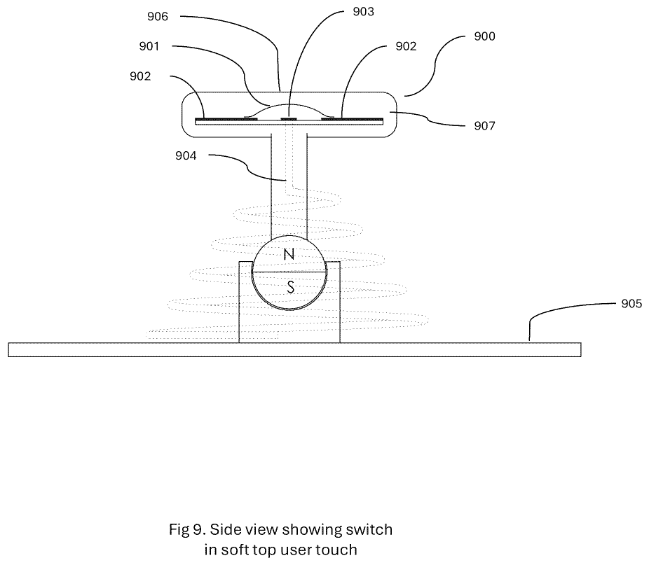

FIG. 9 shows an exemplary embodiment of a top user interface switch 900, and how a dome plate type switch 901 (which may also be any push button type switch) may be used to connect a bigger (or smaller) metal area 902 to an electrical connection point 903. The connection point 903 may further be electrically connected to the sensor IC (not shown) via a spring member 904 in order to measure a step change in measured capacitance to a user finger (not shown). This is related to FIG. 7 wherein the spring 701 further connects or capacitively couples to the tracks 705 (not shown in FIG. 9), which in this embodiment is placed on a pcb 905. The material and shape of the top part 906 of the top user interface switch 900 need to be flexible in order to transfer the user's pressing force to the dome switch 901.

With this embodiment the switch 607 shown in FIG. 6 is not needed and the housing is simplified since the downwards movement to activate the switch 607 (in FIG. 6) is replaced by the user interface switch 900 which is contained in a top cover 907

The invention as shown in FIGS. 8 and 9 can be used with all types of thumb sticks—not only magnetic (TMR or Hall sensors), and also for resistive, capacitive or inductive sensing implementations of the force lever position and orientation.

1. A thumb stick comprising a force lever, a magnet attached to the force lever, a magnetic sensing device comprising a single plane of magnetic field sensors, and a spring which is attached to the force lever and which is configured to move the force lever to a zero or near-zero position when no user actuation happens.

2. The thumb stick of claim 1 which includes a force sensing mechanism to detect when a user is not in contact with the thumb stick or with the force lever.

3. The thumb stick of claim 2 wherein the force sensing mechanism comprises an inductive sensing coil to detect pressure exerted on the force lever, said pressure being transferred to a metallic bracket with a flexible portion which is configured to move relative to the inductive sensing coil.

4. The thumb stick of claim 3 wherein the flexible portion is configured to move closer to the coil when pressure is applied to the force lever.

5. The thumb stick of claim 3 wherein the flexible portion is configured to move further away from the coil when pressure is applied to the force lever.

6. The thumb stick of claim 2 which includes an actuator to provide haptic feedback which is used to inform the user about actuations of the force lever, and about a downward pressure on the force lever exceeding a predetermined level to affect a switch actuation decision.

7. The thumb stick of claim 1 wherein in the magnetic sensing device comprising an integrated circuit and the single plane of magnetic field sensors comprises four Hall-plates.

8. The thumb stick of claim 2 wherein the force sensing mechanism comprises a differential capacitive sensing arrangement that detects pressure exerted on the force lever.

9. The thumb stick of claim 2 wherein when said force sensing mechanism detects that a user is not in contact with the thumb stick nor with the force lever, a processor executes a calibration algorithm to establish an updated zero position.

10. A thumb stick comprising a force lever, a top cover which is attached to one end of the force lever, a magnet which is attached to a second end of the force lever, a spring member, and a capacitive switch structure which comprises an electrode plate, an electrical connection point and a dome switch, and which is encapsulated in the top cover, said electrical connection point being electrically connected to the spring member, said dome switch under pressure, configured to create an electrical connection between the electrode plate and the electrical connection point thereby to form an electrode structure which is responsive to a user touch or press event on the force lever.

11. A method of determining the position and orientation of a force lever of a thumb stick wherein the method includes the step of attaching a magnet that is monitored by a magnetic sensor device which has multiple magnetic sensors in a single plane in an integrated circuit.

12. The method of claim 11 which includes the step of using a force sensor to determine if a user is in contact with the thumb stick or with the force lever.

13. The method of claim 12 which includes the step of using a haptic actuator to provide feedback about actuations of the force lever to the user.

14. The method of claim 12 which includes the steps of measuring an orientation of the force lever, and relating a switch activation decision to a downwards force on the force lever which is dependent on said measured orientation.

15. The method of claim 11 including the step of keeping a distance between the magnet and the magnetic sensor device stable when a user exerts a downwards pressure on the force lever.

16. A method of operating a thumb stick which comprises a user interface force lever, a magnet attached to the force lever, and multiple magnetic sensors positioned to detect and measure magnetic fields of said magnet, wherein the method includes the steps of using said magnetic field measurements from the magnetic sensors to detect vertical (Z-axis) movement of the lever, and to correct a determination of an orientation of the magnet by cancelling deviations caused by vertical movement of the magnet.

17. The method of claim 16 wherein the multiple magnetic sensors comprise four Hall effect sensors in an integrated circuit with co-planar Hall plates.

18. The method of claim 12 which includes the step of executing a calibration procedure to set a updated zero position for the force lever upon detecting that a user is not in contact with the thumb stick nor with the force lever.
